(19) United States
(12) Patent Application Publication
(10) Pub. No.: US 2008/0127102 A1
(43) Pub. Date: May 29, 2008

(54) TECHNIQUE TO VISUALLY PRESENT MEMORY LOCATION AND USAGE DURING CODE EXECUTION

(76) Inventor: Glen J Anderson, Westford, MA (US)

Correspondence Address: Global IP Services PLLC, 198 F, 27th Cross,3rd Block Jayanagar, Bangalore, 560011, omitted

(21) Appl. No.: 11/531,698

(22) Filed: Sep. 14, 2006

(51) Int. Cl. G06F 9/44

(52) U.S. Cl. 717/125

(57) ABSTRACT

A method/technique of allocating object sections of a program to different memory regions of a target processor collects profiling information displaying code-execution-statistics in the memory of the processor. The method loads the program in a current project and arranges, preferably using a user interface link, to obtain a graphic display in profiling bins reflecting statistics pertaining to each of the object sections in the different memory regions. At the end of the program, the profiling bins show time spent in executing each object section, and the location of the corresponding memory section. The graphical display might use differing color intensities of a single color, e.g., red, for the different profiling bins. Other methods of graphical display, e.g., bar graph or sector display are also envisaged. Based on the displayed contents of the profiling bins, a user completes matching the process-intensive object sections with relatively fast sections of the target processor memory.

### FIELD OF THE INVENTION

This invention generally relates to a technique for knowing the memory location usage in a processor or computer, and more particularly, to a technique for managing memory location usage in a processor.

### BACKGROUND OF THE INVENTION

Embedded developers spend much of the product development cycle time in optimizing and tuning their code to take full advantage of the hardware upon which the application runs. A task of great importance to developers is to insure that the most execution-intensive code is placed in the fastest regions of memory to minimize latency introduced by access to the memory. But the challenge is to find an easy method of generically knowing visually how the performance of an application in a processor is distributed throughout the various memory regions of a target processor. Prior Art implementations display code execution analysis with respect to source code files but with no regard to where the code is located in the memory. Typically, users and developers manually analyze complex log files generated for the purpose, to determine where the execution intensive code is located in an application. The data that is discovered might however be irrelevant after each development of the software is completed. In other words, the data discovered during one analysis by the developers becomes useless for the next software application.

### SUMMARY OF THE INVENTION

The present invention provides a technique to display execution statistics in the context of the layout of the physical memory of a processor. In one form, the invention provides a visualization technique by which a user/developer can see how the performance of their application is distributed throughout the various memory regions of the target processor. The visualization technique helps to optimize and tune the code in the computer for a specific application. The computer memory has regions which can work fast, and regions which can work relatively slowly. It is advantageous to shift the process intensive code to the relatively fast regions of the computer memory by using the visual profile data physical memory in a window. In one form, the visualization technique shows in a window, the execution statistics or execution performance metrics of the computer memory layout.

More specifically, the invention teaches the application of graphical representation of a processor's memory layout in a window display. The application uses a technique for visualizing the display execution statistics in the context of a processor's physical memory. Using the technique, a developer/user can optimize and tune the code to take full advantage of the hardware based on which the application runs.

The invention in one form resides in a visualization technique to selectively enable a user to make efficient code distribution in a program throughout memory regions of a target processor, the program having a plurality of object sections, the technique comprising the steps of loading the program in a current project; setting up a plurality of profiling bins to collect profiling information relating to the plurality of object sections; graphically displaying contents of the profiling bins to show an extent of time spent in executing each object section; and, based on the displayed contents of the profiling bins, matching process-intensive ones of the object sections with relatively fast sections of the target processor memory. Expediently, the profiling bins are made to be visible in color, e.g., red, with identifiable differing color intensity, so that the plurality of profiling bins is identified uniquely by different predefined color intensities.

In a modification of the inventive visualization technique, the step of graphically displaying comprises displaying the profiling bins in form of a bar graph or in any other visual measurable form including sector display. Preferably, the step of graphically displaying occurs after execution of said program is over, or, after the program has executed for a suitable length of time such that the profile data is statistically valid. Advantageously, the inventive visualization technique includes the step of indicating a location of each of the different object sections in the memory regions of the target processor. In one form of the invention, the step of collecting profiling information is done while the user is running his program.

In a preferred form, the invention includes the step wherein after the program is loaded, the visualization technique deploys a user interface link to set up profiling bins to collect profiling information.

The invention in another form resides in a method of managing code allocation of a program to sections of a target processor, the program having a plurality of object sections, comprising the steps of: loading the program in a current project, and initiating display of code-execution statistics from within said target processor for the plurality of object sections in a visual measurable form; initiating a user interface link for enabling setting up of code execution profiling bins to display said code execution statistics on a user interface (UI); collecting and graphically displaying profiling information on the UI, reflecting an extent of time spent in processing each said object section in said computer memory; and, based on the profiling information, matching process intensive object sections of the program with relatively fast sections of the computer memory.

Also taught herein is a computer readable medium encoded with data/instruction which when executed by a computing platform, results in execution of the foregoing method.

### BRIEF DESCRIPTION OF THE DRAWING

In the following detailed description of the preferred embodiments, reference is made to the accompanying drawing that forms a part hereof, and in which are shown by way of illustration specific embodiments in which the invention may be practiced. It is understood that other embodiments may be utilized and structural changes may be made without departing from the scope of the present invention. In the accompanying drawing:

FIG. 1 illustrates a screen/window titled Linker Map File, which gives the user the ability to choose “profile execution of object sections” and “show stack/heap usage”;

FIG. 2 illustrates a window showing legends pertaining to icons/colors in the practice of the invention;

FIG. 3 illustrates an exemplary view of a memory map after running and profiling a program; and,

FIG. 4 illustrates a “view function” screen, which can be reached through the memory map of FIG. 3.

### DETAILED DESCRIPTION

A detailed description of one or more embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention.

The present invention may be practiced according to the claims without some or all of these specific details. For the purpose of clarity, technical material that is known in the technical fields related to the invention has not been described in detail so that the present invention is not unnecessarily obscured.

The present technique expediently uses a user interface link for visualizing profiling data in physical memory locations of a target processor. The user interface link can be tailored and enhanced to give users the option/feature of profiling object sections in their program. If the feature is enabled, user interface link will use a profiler plug-in to collect profiling information while the user is running his program. The user interface link is also configured such that when the program halts, the user interface will graphically display how much time was spent in each object section so that the user can see “hot spots” in his code and consider moving that code to faster sections of internal memory in the target processor.

As an example, to profile a program with the user interface link, the user will:
1. Selectively enable profiling in the Global Properties dialog.
2. Load the program in the current project. After the program is loaded, the user interface link will set up the profiling bins to collect the profiling information.
3. Run the program. When the program halts, user interface link will color each object section with a different shade of a chosen color, e.g., red, to indicate how much time was spent executing that section.

The following is noted concerning the user interface Design:

In the Global Properties dialog, a checkbox will be added to enable or disable profiling.

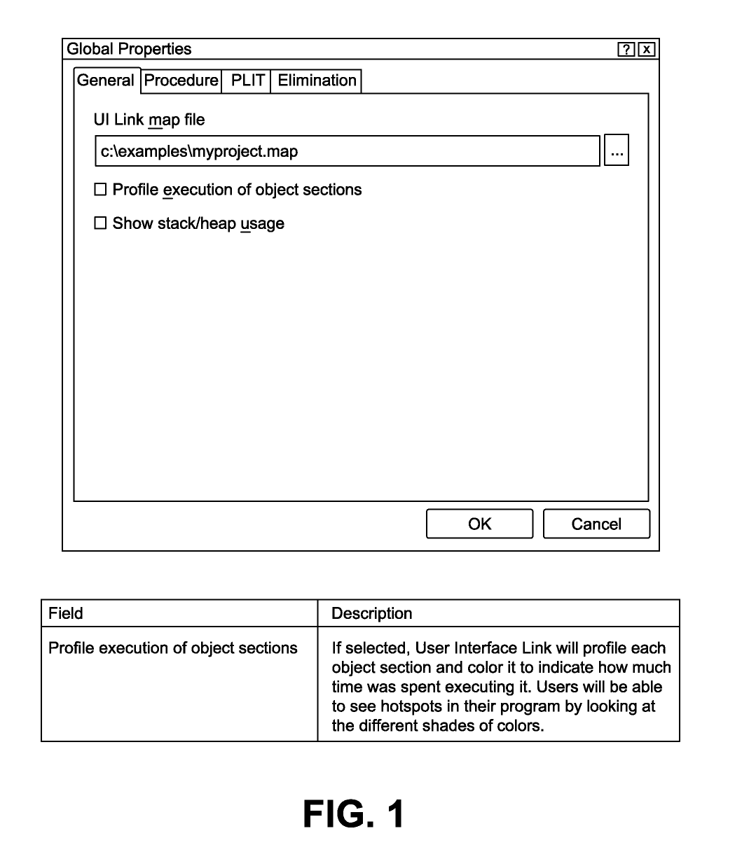

FIG. 1 shows the choice of two fields for Profile Execution of Object Sections, and Show Stack/Heap usage, which the user can select.

If the user chooses the Profile Execution of Object Sections field, then, user interface link will profile each object section and color it to indicate how much time was spent executing it. Users will be able to see hot spots in their program by looking at the different shades of colors.

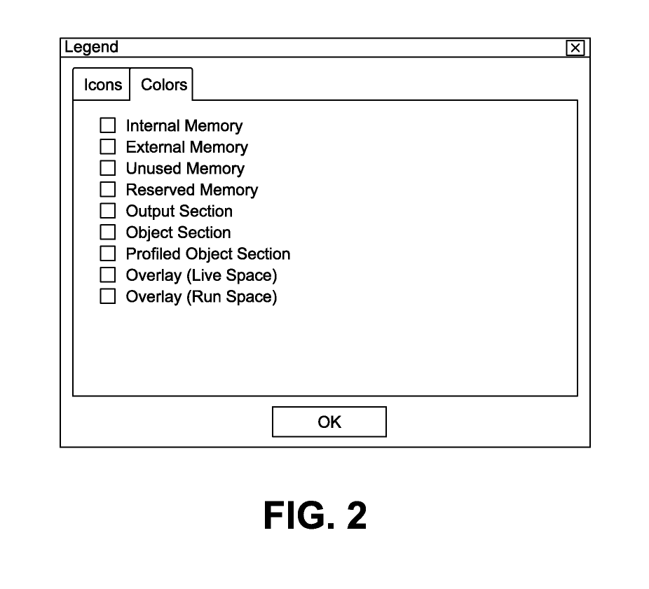

FIG. 2 illustrates an exemplary Legend Dialog wherein a new color might be added for profiled object sections. The new color can be customized by the user.

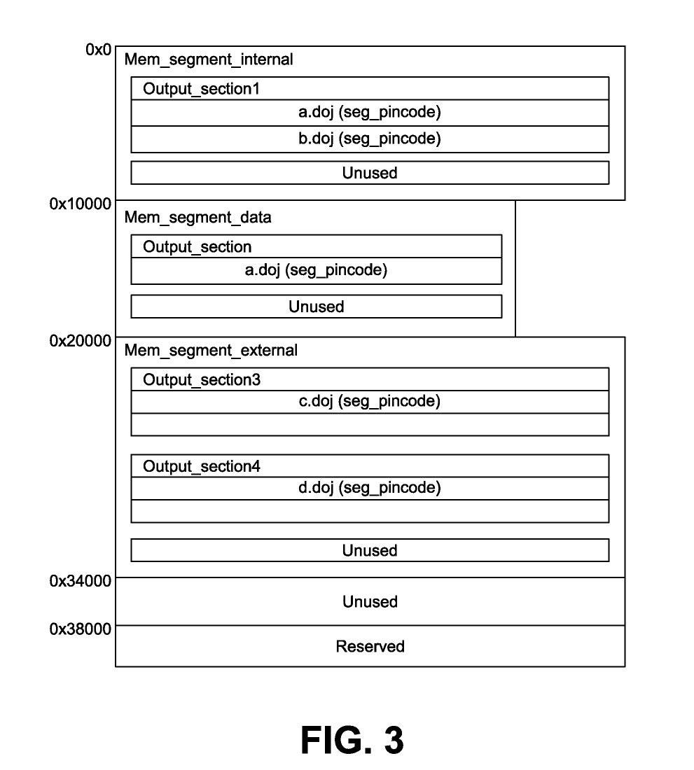

FIG. 3 illustrates a view wherein each profiled object section in the graphical memory map is colored, for example, in a different shade of red, to indicate how much time was spent executing that object section. Expediently, the more the time spent in executing that object section, the brighter the shade of red that is used to display that object section. FIG. 3 indicates how the memory map might look like after running and profiling a program. As aforesaid, instead of the color coding for displaying the profiled program, any other method of dimensional coding display such as a bar graph might be used instead.

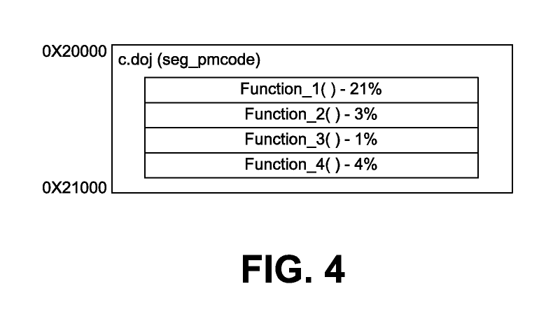

Users will see that as generally illustrated in FIG. 4, c.doj(seg_pmcode) takes up most of the execution time, and the user could in the interest of efficiency drag the c.doj(seg_pmcode) from slower external memory to faster internal memory. Further, if the user wishes to see more detail regarding the c.doj(seg_pmcode), the user can right-click on “View Functions” from the context menu which will pop up. The user will then see the input section with a list of functions in that input section and the percentage of time that was spent in executing each function.

As aforesaid, the functions are expediently color coded to show which object sections are taking up the most execution time. The brighter the red, the more time was spent in executing that function. If the user right-clicks on a function, and clicks on “Go To Function”, the profiling window is configured to open and show the file containing that function. In the window that opens up, the user is able to view the percentage of execution time for each line in the function. The user can zoom out of the input section view, when the user will be taken back to view the regular memory map. Thus, as explained earlier, the technique enables the user to drag the c.doj(seg_pmcode) from slower external memory to faster internal memory, to enhance the efficiency.

Also included herein is a computer medium encoded with data/instruction which when executed by a computing platform will result in a method and a technique as aught hereinabove. Various embodiments of the present subject matter can be implemented in software, which may be run in any suitable computing environment. The embodiments of the present subject matter are operable in a number of general-purpose or special-purpose computing environments. Some computing environments include personal computers, general-purpose computers, server computers, hand-held devices {including, but not limited to, telephones and personal digital assistants (PDAs) of all types}, laptop devices, multi-processors, microprocessors, set-top boxes, programmable consumer electronics, network computers, minicomputers, mainframe computers, distributed computing environments and the like to execute code stored on a computer-readable medium. The embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices. Details of how the present technique can be implemented in a computer readable medium are intelligible to those skilled in the art.

In the foregoing detailed description of embodiments of the invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. The present invention may be practiced according to the claims without some or all of these specific details. For the purpose of clarity, technical material that is known in the technical fields related to the invention has not been described in detail so that the present invention is not unnecessarily obscured. It is understood that the above description is intended to be illustrative, and not restrictive. The description is intended to cover all alternatives, modifications and equivalents as may be included within the spirit and scope of the invention as defined in the appended claims. Many other embodiments will be apparent to those of skill in the art upon reviewing the above description. The scope of the invention should therefore be determined with reference to the appended claims, along with the full scope of equivalents to which such claims are entitled.

1. A visualization technique to selectively enable a user to make efficient code distribution in a program throughout memory regions of a target processor, said program having a plurality of object sections, the visualization technique comprising the steps of:
loading the program in a current project;
setting up a plurality of profiling bins to collect profiling information relating to said plurality of object sections;
graphically displaying contents of said profiling bins to show an extent of time spent in executing each said object section; and,
based on said displayed contents of the profiling bins, matching process-intensive ones of said object sections with relatively fast sections of the target processor memory.

2. The visualization technique as in claim 1, wherein the step of graphically displaying comprises graphically displaying profiling bins on a screen, accessible to a user.

3. The visualization technique as in claim 2, wherein said profiling bins are made to be visible in color, with identifiable differing color intensity, so that the plurality of profiling bins is identified uniquely by different predefined color intensities.

4. The visualization technique as in claim 2, wherein said step of graphically displaying comprises displaying the profiling bins in form of a bar graph.

5. The visualization technique as in claim 1, wherein said step of graphically displaying occurs after execution of said program is over.

6. The visualization technique as in claim 1, including the step of indicating a location of each of said different object sections in said memory regions of said target processor.

7. The visualization technique as in claim 1, wherein the step of collecting profiling information is done while the user is running his program.

8. The visualization technique as in claim 1, including the step wherein after the program is loaded, the visualization technique uses a user interface link to set up profiling bins to collect profiling information.

9. The visualization technique as in claim 8, wherein when the program halts, said user interface link will color each object section with a different shade of red to indicate how much time was spent executing each said object section.

10. The visualization technique as in claim 3, including using a legend dialog wherein a new color is added for profiled object sections.

11. A method of managing code allocation of a program to sections of a target processor, said program having a plurality of object sections, comprising the steps of:
loading the program in a current project, and initiating display of code-execution statistics including location from within said target processor for said plurality of object sections;
initiating a user interface link for enabling setting up of code execution profiling bins to collect said code execution statistics on a user interface (UI) in a visual measurable form;
graphically displaying on said UT, profiling information reflecting an extent of time spent in processing each said object section in said computer memory; and,
based on said profiling information, matching process intensive object sections of said program with relatively fast sections of said computer memory.

12. The method of managing code allocation of a program to sections of a target processor as in claim 11, wherein said profiling bins are made to be visible in color, with identifiable differing color intensity, so that the plurality of profiling bins is identified uniquely by different predefined color intensities.

13. The method of managing code allocation of a program to sections of a target processor as in claim 11, wherein said step of graphically displaying comprises displaying the profiling bins in form of a bar graph.

14. The method of managing code allocation of a program to sections of a target processor as in claim 12, including the step of indicating a location of each of said different object sections in said memory regions of said target processor.

15. The method of managing code allocation of a program to sections of a target processor as in claim 11, wherein the step of collecting profiling information is done while the user is running said program.

16. The method of managing code allocation of a program to sections of a target processor as in claim 11, wherein when the program halts, said user interface link will color each object section with a different shade of red to indicate how much time was spent executing each said object section.

17. The method of managing code allocation of a program to sections of a target processor as in claim 11, including using a legend dialog wherein a new color is added for profiled object sections.

18. A method of allocating object sections of a program to different regions of a target processor for processing, comprising the steps of:
loading the program in a current project and arranging to see profiling bins reflecting profiling information pertaining to each of said object sections and said different regions;
graphically displaying contents of said profiling bins to show an extent of time spent in executing each said object section; and,
based on said displayed contents of the profiling bins, matching process-intensive ones of said object sections with relatively fast sections of the target processor memory.

19. The method of allocating object sections of a program to different regions of a target processor for processing as in claim 18, wherein said profiling bins are made to be visible in color, with identifiable differing color intensity, so that the plurality of profiling bins is identified uniquely by different predefined color intensities.

20. The method of allocating object sections of a program to different regions of a target processor for processing as in claim 18, wherein said step of graphically displaying occurs after execution of said program is over.

21. The method of allocating object sections of a program to different regions of a target processor for processing as in claim 20, including the step wherein said profiling bins are colored in differing shades of red to indicate differing time slots spent in executing each said object section in the target processor.
